(19) United States
(12) Patent Application Publication
(10) Pub. No.: US 2008/0115178 A1
(43) Pub. Date: May 15, 2008

(54) CUSTOMER CONFIGURABLE VIDEO RICH NAVIGATION (VRN)

(75) Inventor: Roger J. Godin, Berkeley, CA (US)

Correspondence Address: BROOKS KUSHMAN P.C., 1000 TOWN CENTER, TWENTY-SECOND FLOOR, SOUTHFIELD, MI, 48075, US

(73) Assignee: COMCAST CABLE HOLDINGS, LLC, Philadelphia, PA (US)

(21) Appl. No.: 11/554,143

(22) Filed: Oct. 30, 2006

(51) Int. Cl. H04N 7/173; H04N 7/16

(52) U.S. Cl. 725/97; 725/115; 725/145; 725/86

(57) ABSTRACT

A method and system of supporting customer configurable video rich navigation (CC-VRN). The CC-VRN associated with facilitating customer selection of video or other contents streams for simultaneous display within a user interface having a number of navigable features associated with navigating the user to other services.

### BACKGROUND OF THE INVENTION

1. Field of the Invention

The present invention relates to customer configurable video rich interfaces for use in selecting content for viewing and other purposes.

2. Background Art

Video rich navigation (VRN) generally refers to a concept of providing customers within user interfaces enhanced with video or other moving content. This concept improves upon existing electronic programming guides (EPGs) and other similar menu based interfaces. The use of VRN interfaces is advantageous to media services providers as it improves customer satisfaction and ease of viewing with respect to menu, grid and other limited text based interfaces.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for supporting content or video based rich navigation (VRN) in accordance with one non-limiting aspect of the present invention;

FIG. 2 schematically illustrates operation of one or the customer devices in accordance with the present invention;

FIG. 3 illustrates a listings based user interface for selecting the content streams in accordance with one non-limiting aspect of the present invention;

FIG. 4 illustrates a video based user interface for selecting the content streams in accordance with one non-limiting aspect of the present invention.

FIG. 5 illustrates an exemplary VRN overlay in accordance with one non-limiting aspect of the present invention; and

FIG. 6 illustrates the overlay being populated with content streams in accordance with one non-limiting aspect of the present invention.

### DETAILED DESCRIPTION OF THE PREFERRED EMBODIMENT(S)

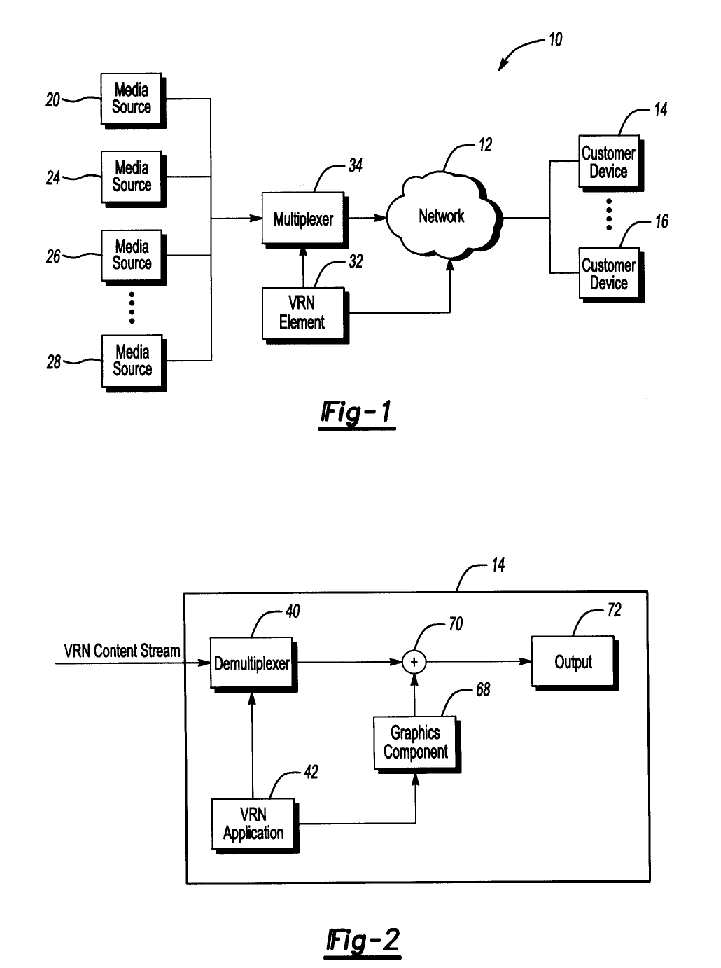

FIG. 1 illustrates a system 10 for supporting content or video based rich navigation (VRN) in accordance with one non-limiting aspect of the present invention. The system 10 generally relates to a customer or subscriber based system where a media service provider (not shown) provides any number of services over an electronic network 12 to any number of customer devices 14-16 associated with one or more customers, such as but not limited to the system disclosed in U.S. Ser. No. 11/093,627, the disclosure of which is hereby incorporated in its entirety.

The media provider, for exemplary purposes, is most prominently described with respect to being a cable television service provider having capabilities for providing cable television, telecommunications, and high-speed data services to the subscriber locations, primarily through wireline and/or wireline communications. The present invention, however, is not so limited and fully contemplates the provider being associated with any type of service provider, including other television providers (IP, broadcast, satellite, etc.) and non-television providers, such as those associated with high-speed data, telecommunications, cellular communications, and the like.

The media provider may be configured to support and/or facilitate the use of any number of television and non-television services and applications, such as, but not limited to linear and non-linear television programming/signaling (cable, satellite, broadcast, etc.), Video on Demand (VOD), interactive television (iTV), email services, data transmission service, interactive gaming, pay-per-view (PPV), digital video recording (local and remote), and/or broadcasting of signals associated with supporting television programming, movies, audio, and other multimedia, as well as, downloading of clips or full-length versions of the same.

The network 12 may include any number of features and devices to facilitate signal transportation and other operations associated with interfacing the subscriber locations with each other and otherwise supporting communications associated with services of the media provider. The network 12 may include terrestrial and extraterrestrial components and infrastructures, including cable lines, telephone lines, and/or satellite or other wireless architectures. The network 12 may be associated with other private and/or public networks, such as the Internet and dedicated or virtual private networks.

Each subscriber location may include one or more customer devices 14-16, such as but not limited to a settop box (STB), digital video recorder (DVR), personal computer (PC), television (which may include embedded user interface and processing capabilities), outlet digital adapter (ODA), media terminal adapter (MTA), cable modem (CM), personal digital assistant (PDA), computer, mobile device (phone, computer, etc.), personal media device, and any other item having capabilities to supporting access to any number of the services.

The customer devices 14-16 may be configured to descramble and to support and/or facilitate the use of any number of television and non-television related signals, such as, but not limited to, NTSC television, ATSC television, MPEG digital television, Real-Time Streaming Protocol (RTSP), Hyper Text Transfer Protocol (HTTP), Dynamic Host Configuration Protocol (DHCP), Syslog, Simple Network Management Protocol (SNMP), Trivial File Transfer Protocol (TFTP), Data Over Cable Service Interface Specification (DOCSIS), Domain Name Server (DNS) applications, DOCSIS Settop Gateway (DSG), out-of-band (JOB) messaging, and others.

A number content/media sources 20-28 may be associated with and/or controlled by the media provider (which in turn may receive the content from other sources) to source content streams and/or one or more of the subscriber devices or other non-subscriber devices connected the network 12 may similar source content, such as but not limited to peer-to-peer environments. For example, if the media provider is a television service provider, a portion of the media content may relate to television programs, movies, and other multimedia packets. This content may be delivered from the contents sources 20-28 to the subscribers through streaming, downloading, broadcast, peer-to-peer, and any number of other processes.

The media content may be delivered to the subscriber locations directly from the media service provider and/or from one or more of the other devices in communication therewith. As is common with larger media content providers, multiple regional enterprises, such as headend units and the like, may be configured to provide regional programming to a number of subscribers associated therewith. Each of the headends may store various types of media content for distribution to the subscribers it services. Optionally, the headends may be configured to support headend to headend communications such that non-direct subscribers, i.e., those supported by other headends, may similarly receive content from other headends.

Optionally, a portion of the media content may be sourced from the subscribers themselves, such as by transporting content stored locally on the home networks of the subscribers to other locations within the same home network and/or to other locations beyond the home network that are in communication therewith by way of the network. The media provider may include features and capabilities to facilitate such inter-subscriber communications.

The system 10 may further include a VRN 32 element to facilitate VRN related operations required in accordance with the present invention. The VRN element 32 may include memories, processors, and/or other features necessary to the operations of the present invention. It may be a standalone item and/or integrated into the operations of one or more other elements in communication with the system 10. The media service provider may control operations of the VRN element 32 and/or the VRN element may be support or otherwise controlled by a third party.

One of the VRN related operations of the present invention may relate to directing and/or otherwise facilitating multiplexing content streams from the content sources 20-28 into a common VRN distribution channel. The VRN distribution channel may include any number of content streams associated with supporting VRN in accordance with the present invention. A multiplexer 34 may be in communication with the VRN element 32 or otherwise associated therewith to facilitate the multiplexing operations. The multiplexer may then transport the VRN distribution channel to the customer devices over the network 12 or other suitable communication medium.

The operations of the multiplexer 34 may generally correspond with multiplexing multiple content streams and any associated control information into the common VRN distribution channel and the operations associated therewith. Optionally, this may include multiplexing content streams associated with a number of VOD, television channels, or other content streams (gaming, interactive television, data, etc.) offered by the media provider into the single VRN distribution channel. The VRN distribution channel may be associated with the bandwidth commonly associated with a single QAM television channel such that the content associated with the multiple content streams may be accessed by tuning to or otherwise processing the single VRN distribution channel.

For example, each of the content sources 20-28 may be associated with a particular television service such that the content stream associated therewith occupies less bandwidth typically associated with a single QAM channel before being multiplexed. The multiplexer adjusts each stream as a function of the number of other multiplexed streams so that each stream can be included within the single channel bandwidth of the common VRN distribution channel. The resolution or other parameters (bandwidth) of particular content streams may take precedent over other streams such that each stream is not necessarily required to occupy equal portions of the VRN distribution channel bandwidth.

The content streams may be scaled down to approximately 140×90 pixels in size, and optionally thereafter compressed. Advanced coding, i.e. AVC, VC1, etc., may be used such that the estimated bit rate for each processed content stream may be on the order of 150 kbps. The associated audio may be encoded to use AAC with a target rate of 56 kbps. The VRN distribution channel may comprise individual content streams having bandwidth requirements of 206 kpbs (150+56 kpbs) such that the typically channel (256 QAM), which may include approximately 180 content streams.

The ability to multiplex multiple content streams into a common VRN distribution channel allows the present invention to provide a common channel having, in essence, multiple channels (content streams) of its own such that each of the content streams may be demultiplexed from the VRN distribution channel for customer viewing, as described below in more detail. The present invention, however, is not necessarily so limited and fully contemplates including any number of content streams within the VRN distribution channel and not necessarily limiting the VRN distribution channel to a single QAM channel.

The VRN element 32 may be configured to keep track of or otherwise assess the channels or content streams included within the common VRN distribution channel. This may include mapping or otherwise correlating source channel IDs associated with each of the channels to a VRN ID. The VRN element 32 may create a table, database, or other relational entity to support correlating the IDs, which for exemplary purposes may be referred to as a content source mapping table. If different channels or content streams are added to or removed form the VRN distribution channel, the VRN element may make corresponding changes to the content source mapping table. The VRN element may originate control information such as display rules, graphic overlay objects and timing data into the VRN distribution channel for use by a client application.

For exemplary purposes only, and without intending to limit the scope and contemplation of the present invention, operations of the VRN element 32 are predominately described with respect to supporting operations associated with the formation of a single VRN distribution channel having streams from multiple content sources commonly employed with cable television operations. The present invention, however, is not so limited and fully contemplates the formation of any number of separate VRN distribution channels and supporting the use thereof. The various VRN distribution channels may be transmitted to any number of local or national customer devices and/or specifically transmitted to one or more customer devices.

FIG. 2 schematically illustrates operation of one or the customer devices 14 in accordance with the present invention. As noted above, the present invention contemplates the customer devices 14-16 being associated with any type of user device suitable for interfacing customers with services of the media provider. The customer devices 14-16, in order to facilitate one or more of the operations of the present invention, may include features associated with supporting the operations associated with the schematically illustrated elements.

The customer device 14 may include a demultiplexer 40 to facilitate demultiplexing the VRN distribution channel. The demultiplexing may generally related to demultiplexing one or more of the content streams included within the VRN distribution channel for customer usage. The demultiplexer 40 may rely on the content source mapping table to facilitate selecting and demultiplexing the content streams. Because the content streams included in the VRN distribution channel may be of a lower resolution than the original content stream, the demultiplexed signals may be of a corresponding lower resolution and/or the demultiplexer may apply enhancements or other resolution techniques to improve upon the resolution thereof.

The customer device 14 may be loaded with or otherwise configured to include a VRN application 42. The VRN application 42 may be a controller or other suitably executing entity having capabilities to facilitate video rich navigation in accordance with the present invention. The VRN application 42 may be configured to support user selection of the demultiplexed content streams and related navigation, including executing conditional access operations for one or more of the content streams if necessary. As described below in more detail, the user may control which one or more content streams are shown within a navigable user interface so as to provide video rich navigation with an interface having navigable selection options associated with accessing other features supported for the corresponding customer.

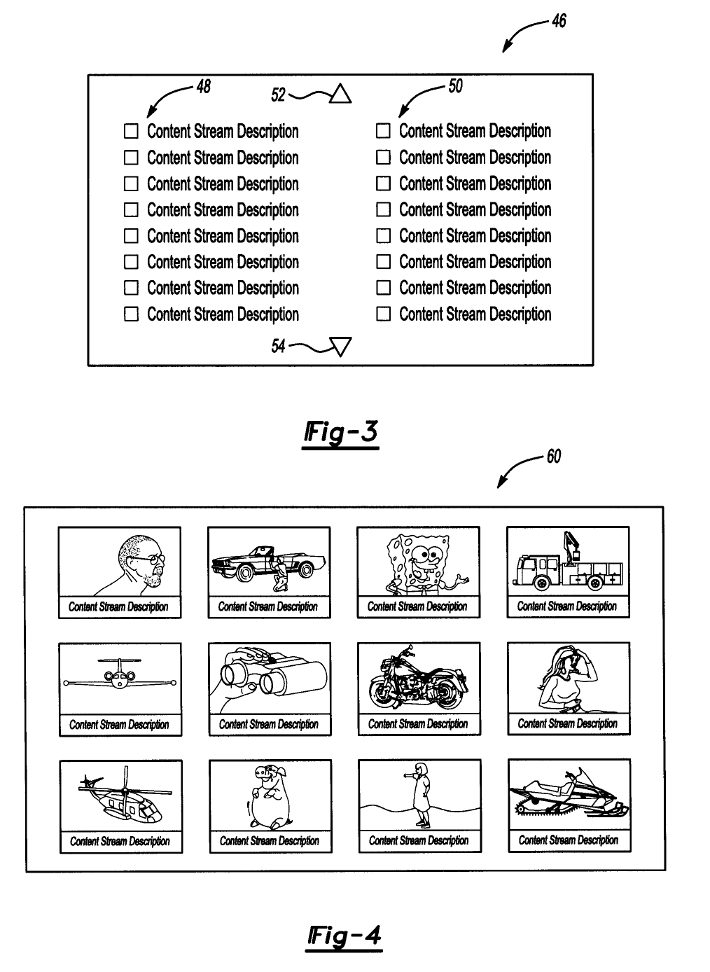

FIG. 3 illustrates a listings based user interface 46 for selecting the content streams in accordance with one non-limiting aspect of the present invention. The listing user interface 46 may be present through an electronic programming guide (EPG) or other navigable feature operating on the customer device 14. Upon access to the listing menu 46, the VRN application 42 may populate the user interface 46 with a title listing or other description of the content streams included within the VRN distribution channel (or one of the VRN distribution channels depending on the number of VRN distribution channels available to customer device).

The titles or other descriptor used to reference the content streams may be derived from metadata or other data associated with the content streams. This data may be included within the VRN content source mapping table or otherwise communicated to the VRN application 42. The listing may be arranged according to the typical channel map used by the customer device and/or according to some other methodology, such as but not limited to favorites, recommendations, genres, channel types, movies, and any number of other classifiable and non-classifiable orders.

The user may select one or more of the listings by selecting one or more check boxes from check box columns 48-50 or through some other selection process facilitate through the interface 46. This information may then be used by the demultiplexer for demultiplexing the corresponding content streams from the VRN distribution channel when presenting VRN navigation user interface. Control arrows 52-54 may be included to facilitate scanning or otherwise navigating through the available content streams and/or some other feature may be included, such as but not limited to navigating to channels as a function of inputted channel numbers, titles, descriptions, etc. The demultiplexer may recover the selected content stream from the VRN distribution channel for further processing in accordance with the present invention.

FIG. 4 illustrates a video based user interface 60 for selecting the content streams in accordance with one non-limiting aspect of the present invention. The video user interface 60 may be present in a manner similar to the presentation of the listing user interface, such as but not limited to presentation through the EPG or other navigable feature operating on the customer device. Upon access to the video menu, the VRN application 42 may populate the user interface with a thumbnail streaming or live showing of one or more of the content sources available for selection within the VRN distribution channel. This may require correlating the user interface with simultaneous demultiplexing of the VRN distribution channel in order to recover and playback the content streams within the user interface.

The user interface 60 may include a highlighter or other selection feature (not shown) to facilitate selecting one or more of the content streams for further processing. The user interface may present the content stream in a manner similar to or different form the presentation of the titles in the listings based user interface. The user interface of FIG. 4—as opposed to the user interface of FIG. 3, which is non-video based—allows the user to select content streams for further processing as a function of the content actually showing within the content stream and not as just a metadata description associated with the same.

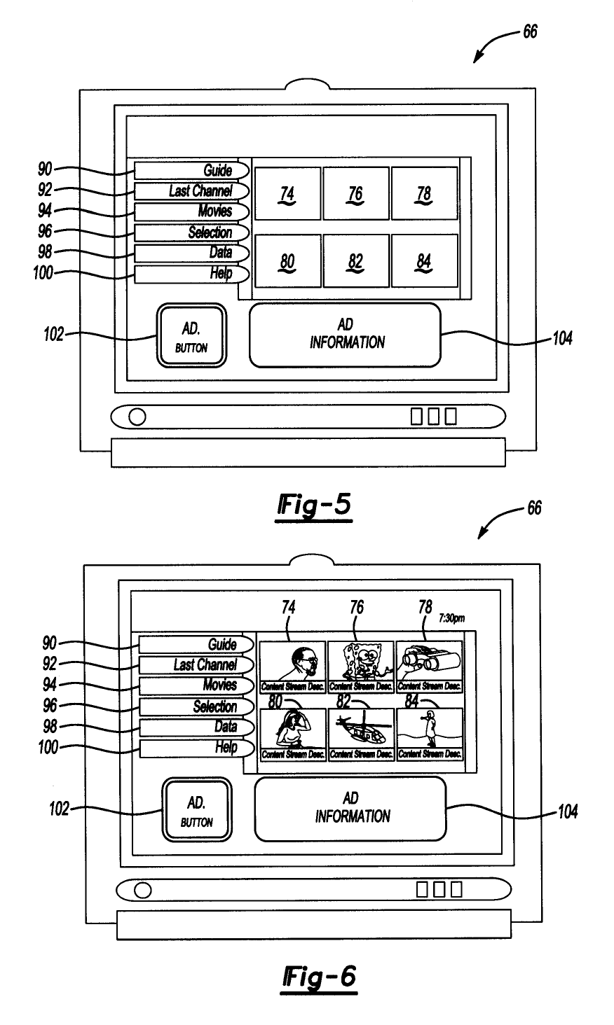

FIG. 5 illustrates an exemplary VRN overlay 66 in accordance with one non-limiting aspect of the present invention. The overlay 66 may be added with a graphical component 68 of the customer device 14 for inclusion with the one or more of the content streams selected in FIG. 3 or 4, or selected through some other selection process, such as but not limited to an automated or pre-defined selections process. The overlay 66 may be added to a video stream having the selected content streams with a video orientation element 70 so as to populate a screen of an output device 72 with images and navigation features, as describe below in more detail.

The content streams and overlay be selected or otherwise directed by the customer. As noted above, the customer may be presented with an interface to facilitate selecting the content streams. The customer may also be present with an interface (not shown) to facilitate selecting the overlay. With the customer driven selection of one or both of these elements, one non-limiting aspect of the present invention advantageously provides a customer configurable VRN (CC-VRN) user interface.

Referring to FIG. 5, the overlay may include a number of windows 74-84 and navigation features 90-104 (menus, buttons, etc). The windows 74-84 may provide viewing areas for the selected content streams. The number of windows 74-84 may be coordinated by the VRN application 42 with the number of selected content streams and/or a feature may be included to switch between which one or more of the content streams are shown in the widows 74-84. The navigation features 90-104 may include selectable buttons for toggling to other navigation items accessible through the user interface.

The navigation features 90-104 may includes a “Guide” button 90 for tuning to an electronic programming guide or other feature which may provide another user interface for reviewing programs shown on other channels, a “Last Channel” button 92 for tuning to the last channel viewed before instigating the CC-VRN interface associated with the homepage user interface, a “Movies” button 94 for tuning to a different guide associated with a movies-themed user interface or for displaying a guide related thereto, a “Selection” button 96 for retuning to one of the content stream selecting user interfaces (FIGS. 3 and 4) so as to facilitate selecting new content streams for viewing, a “Data” button 98 for navigating to a web-portal or other high-speed data application or user interface accessible through the user interface, and a “Help” button 100 for instructing the media device to display a help menu. Of course, other selectable menu options are also fully contemplated. Optionally, the VRN application may analyze other capabilities of the customer device and populate the menus with feature associated with navigating to those capabilities.

The overlay may further include menus for displaying advertisements 102 and user interactive advertisements 104. The advertisements may be based on viewing or other habits of the user, user preferences/profiles, and/or upon information associated with the metadata of the selected content streams. In this manner, the menus and selection buttons (including those associated with navigating to other accessible features of the customer device) may be correlated with the selected content streams or other customer determined influences to create the CC-VRN of the present invention.

FIG. 6 illustrates the overlay 66 being populated with the content streams in order to provide the CC-VRN in accordance with one non-limiting aspect of the present invention. The selected content streams may be arranged proximate the windows 74-84 such that video is viewable through the windows 74-84. The menu and selection options 90-104 may be correlated with the windows 74-84 and/or the content streams showing within the windows. The CC-VRN thus includes user selected video and optionally user selected or determined navigation features, menus, and advertisements.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of providing customer configurable video rich navigation (CC-VRN), the method comprising:
multiplexing multiple content streams into a common VRN distribution channel; and
at a customer device, selecting and displaying one or more of the content streams in the VRN distribution channel in order to support a user navigable interface.

2. The method of claim 1 further comprising scaling down the content streams prior to multiplexing the streams within the VRN distribution channel.

3. The method of claim 2 further comprising displaying one or more of the scaled down content streams within the user interface.

4. The method of claim 1 further comprising mapping the multiplexed content streams for use in facilitating the user selection thereof.

5. The method of claim 1 further comprising providing a content stream selection user interface at the customer device to facilitate selection of the content streams.

6. The method of claim 5 configuring the content stream selection user interface to include a listing of the content streams included within the VRN distribution channel.

7. The method of claim 6 further comprising generating the listing as a function of the metadata associated with the content streams.

8. The method of claim 5 further comprising configuring the content stream selection user interface to simultaneously display at least a portion of the content streams included within the VRN distribution channel.

9. The method of claim 1 further comprising providing navigation features within the user interface as a function of the selected content streams.

10. The method of claim 1 further comprising generating an overlay at the customer device for use in displaying user selectable features proximate to the displayed content streams.

11. The method of claim 1 further comprising transmitting the VRN distribution channel to the customer device over cable television network from a multiplexer located remotely from the customer device, the multiplexer being used to multiplex the content streams into the VRN distribution channel.

12. The method of claim 1 further comprising arranging the selected content streams relative to navigable features associated with an overlay, wherein the content stream area arranged at the customer device and the overlay is added relative to the selected content stream at the customer device.

13. A system of providing customer configurable video rich navigation (CC-VRN), the system comprising:
a common VRN distribution channel having multiple video streams; and
a customer device configured for allowing customer based selection of one or more of the video streams for display relative to a number of navigation features so as to provide CC-VRN.

14. The system of claim 13 further comprising a multiplexer for multiplexing multiple content streams into the VRN distribution channel.

15. The system of claim 14 wherein the multiplexer is configured for scaling down the content streams prior to correspond with a single QAM channel used for transmitting the VRN distribution channel.

16. The system of claim 13 wherein the customer device is configured for providing a content stream selection user interface to facilitate selection of the video streams.

17. The system of claim 16 wherein the content stream selection user interface includes a listing of the video streams included within the VRN distribution channel.

18. The system of claim 16 wherein the content stream selection user interface is configured to simultaneously display at least a portion of the video streams included within the VRN distribution channel.

19. The system of claim 13 wherein the customer device is configured for providing navigation features within the user interface as a function of the selected video streams.

20. The system of claim 13 wherein the customer device is configured including an overlay having the navigation features with the selected video streams.
